(19) United States
(12) Patent Application Publication
(10) Pub. No.: US 2019/0210586 A1
(43) Pub. Date: Jul. 11, 2019

(54) DRIVE MODE SWITCH CONTROLLER, METHOD, AND PROGRAM

(71) Applicant: OMRON Corporation, Kyoto-shi, KYOTO (JP)

(72) Inventors: Tomoyoshi AIZAWA, Kyoto-shi (JP); Hatsumi AOI, Kyoto-shi (JP); Kazuyoshi OKAJI, Kyoto-shi (JP); Hiroshi SUGAHARA, Kyoto-shi (JP); Michie UNO, Kyoto-shi (JP); Koji TAKIZAWA, Kyoto-shi (JP)

(73) Assignee: OMRON Corporation, Kyoto-shi, KYOTO (JP)

(21) Appl. No.: 16/335,287

(22) PCT Filed: Jul. 20, 2017
(86) PCT No.: PCT/JP2017/026346

§ 371 Date: Mar. 21, 2019

(30) Foreign Application Priority Data
Mar. 9, 2017 (JP) 2017-045173

(51) Int. Cl. B60W 10/20; B62D 5/04; B60W 50/08; B60W 30/182; G05D 1/00; G05D 1/02

(52) U.S. Cl. CPC B60W 10/20; B62D 5/04; B60W 50/082; G05D 2201/0213; G05D 1/0061; G05D 1/0212; B60W 30/182

(57) ABSTRACT

A drive mode switch controller receives a switch request for switching from a manual drive mode to an automatic drive mode when switching the drive mode of a vehicle between the manual drive mode and the automatic drive mode. The drive mode switch controller outputs, in response to the received switch request, a first switch signal for switching from the manual drive mode to the automatic drive mode, and a disconnecting command for disconnecting the steering wheel from the wheels of the vehicle.

### FIELD

The present invention relates to a drive mode switch controller, a drive mode switch control method, and a drive mode control program for switching the drive mode of a vehicle between a manual drive mode and an automatic drive mode.

### BACKGROUND

In addition to a manual drive mode for driving a vehicle with a driving operation performed by a driver, an automatic drive mode has been developed for driving a vehicle along a predetermined route without a driver performing a driving operation. The automatic drive mode enables automatic driving of a vehicle by controlling, for example, a power unit, a steering unit, and a brake based on information generated by a navigation system using a global positioning system (GPS), traffic information obtained through road-to-vehicle communication, and information from a surrounding monitoring system that monitors the positions and movements of nearby pedestrians and vehicles (refer to, for example, Japanese Unexamined Patent Application Publication Nos. 2016-210220 and 2016-132264).

In the automatic drive mode, the driver can stop operating, for example, the steering wheel after switching from the manual drive mode. This reduces the burden of the driving operation performed by the driver. When a driving operation performed by a driver is detected in the automatic drive mode (hereafter, an override operation), the state of the driver is determined, and then the drive mode is switched to the manual drive mode.

However, the inventors of the present invention have noticed that automatic driving using the automatic drive mode described above does not reflect the driver's intention and thus can be improved.

For example, the driver is likely to continue holding and operating the steering wheel as in a manual operation immediately after switching from the manual drive mode to the automatic drive mode. The driver may feel uncomfortable in immediately releasing the steering wheel, and may thus intend to stop operating the steering wheel after feeling that the drive mode has been actually switched to the automatic drive mode.

Despite this intension of the driver, the driver operating the steering wheel during automatic driving may be detected as an override operation, which can switch the drive mode from the automatic drive mode to the manual drive mode.

One or more aspects of the present invention are directed to a drive mode switch controller, a drive mode switch control method, and a drive mode switch control program for enabling a driver to feel actual switching to an automatic drive mode while preventing switching to a manual drive mode.

### SUMMARY

In response to the above issue, a drive mode switch controller according to a first aspect of the present invention is for switching a drive mode of a vehicle between a manual drive mode and an automatic drive mode. The controller includes a switch request receiver that receives a switch request for switching from the manual drive mode to the automatic drive mode, a switch signal output unit that outputs, in response to the switch request received by the switch request receiver, a first switch signal for switching from the manual drive mode to the automatic drive mode, and a disconnecting command for disconnecting a steering wheel from wheels of the vehicle.

The controller according to the first aspect of the present invention receives a switch request for switching from the manual drive mode to the automatic drive mode, and outputs a first switch signal for switching from the manual drive mode to the automatic drive mode in response to the switch request, and outputs a disconnecting command for disconnecting the steering wheel from the wheels of the vehicle. Thus, the driver operating the steering wheel can confirm that the steering wheel is no longer interconnected with the wheels after switching to the automatic drive mode, thus feeling actual switching to the automatic drive mode. Further, the steering wheel is no longer interconnected with the wheels, thus preventing switching from the automatic drive mode to the manual drive mode.

A drive mode switch controller according to a second aspect of the present invention is the drive mode switch controller according to the first aspect in which the switch signal output unit includes a command output unit that outputs, when a predetermined time period passes after the disconnecting command is output, an interconnecting command for interconnecting the steering wheel with the wheels of the vehicle.

The controller according to the second aspect of the present invention outputs the interconnecting command for interconnecting the steering wheel with the wheels of the vehicle when the predetermined time period passes after the disconnecting command is output. This structure interconnects the steering wheel with the wheels after allowing the driver to feel actual switching to the automatic drive mode. This structure enables switching to the manual drive mode with the steering wheel interconnected with the wheels at an appropriate position in response to an override operation performed in the interconnected state during automatic driving.

A drive mode switch controller according to a third aspect of the present invention is the drive mode switch controller according to the second aspect further including an operation detector that detects, in response to a detection signal output from an in-vehicle sensor for detecting a driving operation of a driver, an override operation of the driver. The switch signal output unit includes an override processor that outputs a second switching signal for switching from the automatic drive mode to the manual drive mode in response to the override operation detected by the operation detector while the steering wheel and the wheels are interconnected during driving control in the automatic drive mode, and outputs no second switching signal in response to the override operation detected while the steering wheel and the wheels are disconnected during driving control in the automatic drive mode.

The controller according to the third aspect of the present invention detects an override operation performed by the driver in response to the detection signal output from the in-vehicle sensor for detecting the driver's driving operation, outputs the second switch signal for switching from the automatic drive mode to the manual drive mode when detecting an override operation while the steering wheel and the wheels are interconnected during driving control in the automatic drive mode, and outputs no second switch signal when detecting an override operation while the steering wheel and the wheels are disconnected. In the disconnected state after switching to the automatic drive mode, the driver performing an override operation can confirm that the wheels are no longer interconnected with the override operation, feeling actual switching to the automatic drive mode. Also, in response to an override operation detected while the steering wheel and the wheels are disconnected, no second switch signal is output for switching to the manual drive mode.

A drive mode switch controller according to a fourth aspect of the present invention is the drive mode switch controller according to the second or third aspect further including a determination unit that determines whether the driver has hands being off the steering wheel. The command output unit outputs the interconnecting command before the predetermined time period passes when a determination result from the determination unit indicates that the driver has the hands being off the steering wheel.

The controller according to the fourth aspect of the present invention determines whether the driver has his or her hands off the steering wheel, and outputs the interconnecting command before the predetermined time period passes when the determination result indicates that the driver has his or her hands off the steering wheel. Thus, the steering wheel can be interconnected with the wheels before the predetermined time period passes when the driver feels actual switching to the automatic drive mode earlier.

A drive mode switch controller according to a fifth aspect of the present invention is the drive mode switch controller according to any one of the second to fourth aspects in which the interconnecting command moves the steering wheel to a rotational position coordinated with an orientation of the wheels before interconnecting the steering wheel with the wheels.

The controller according to the fifth aspect of the present invention outputs the interconnecting command that moves the steering wheel to a rotational position coordinated with the orientation of the wheels before interconnecting the steering wheel with the wheels. Thus, the steering wheel is moved toward the rotational position coordinated with the orientation of the wheels during shifting from the disconnected state to the interconnected state.

A drive mode switch controller according to a sixth aspect of the present invention is the drive mode switch controller according to any one of the first to fifth aspects in which the disconnecting command disconnects the steering wheel from the wheels in steer-by-wire control that achieves interconnection between the steering wheel and the wheels using electric signals.

The controller according to the sixth aspect of the present invention outputs the disconnecting command for disconnecting the steering wheel from the wheels in steer-by-wire control that achieves interconnection between the steering wheel and the wheels using electric signals. The controller can thus be used for a vehicle with steer-by-wire control.

The drive mode switch controller, method, and program according to the above aspects of the present invention allow a driver to feel actual switching to the automatic drive mode while preventing switching to the manual drive mode.

### BRIEF DESCRIPTION OF THE DRAWINGS

FIG. 1 is a schematic diagram of an automatic driving control system including a drive mode switch controller according to one embodiment of the present invention.

FIG. 2 is a functional block diagram of the drive mode switch controller according to the embodiment of the present invention. FIG. 3 is a flowchart showing the procedure and the control for switching the drive mode performed by the drive mode switch controller shown in FIG. 2.

FIG. 4 is a functional block diagram associated with step S1 in the flowchart shown in FIG. 3.

FIG. 5 is a functional block diagram associated with steps S2 to S6 and step S10 in the flowchart shown in FIG. 3.

FIG. 6 is a timing chart showing drive modes and interconnected or disconnected states in correspondence with the steps in the flowchart shown in FIG. 3.

### DETAILED DESCRIPTION

One or more embodiments of the present invention will now be described with reference to the drawings.

### Embodiment

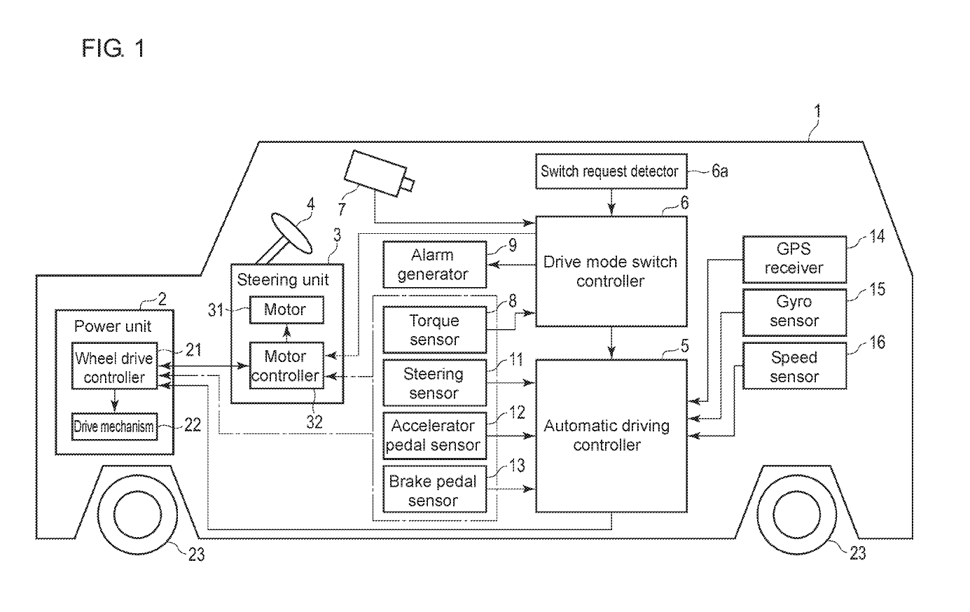

FIG. 1 is a schematic diagram of an automatic driving control system including a drive mode switch controller according to one embodiment of the present invention.

The automatic driving control system is mounted on a vehicle 1, such as an automobile.

The vehicle 1 includes, as its basic components, a power unit 2 including a power supply (not shown), a wheel drive controller 21, and a drive mechanism 22, and a steering unit 3 incorporating a steering wheel 4. The vehicle 1 has two drive modes, a manual drive mode and an automatic drive mode. The power supply includes an engine, a motor, or both. The wheel drive controller 21 controls the drive mechanism 22 and a motor controller 32 based on detection signals from sensors 8 and 11 to 13, which each detect a driving operation, and a control signal from an automatic driving controller 5. The drive mechanism 22 is controlled by the wheel drive controller 21, and drives wheels 23. The wheels 23 can be driven using any drive system such as front-wheel drive, rear-wheel drive, or four-wheel drive as appropriate. The steering unit 3 includes a motor 31 for controlling the rotational position of the steering wheel 4, and the motor controller 32 for controlling the motor 31. The steering unit 3 uses the motor 31 and the motor controller 32 to interconnect the rotational position of the steering wheel 4 with the orientation of the wheels 23. The motor controller 32 controls the motor 31 based on detection signals from the sensors 8 and 11, which each detect the state of the steering wheel, wheel state information received from the wheel drive controller 21, and a command received from a drive mode switch controller 6. During automatic driving, the motor controller 32 may control the motor 31 based on wheel state information received from the automatic driving controller 5 instead of the wheel state information received from the wheel drive controller 21. Although the vehicle 1 performs steer-by-wire control for interconnecting the steering wheel 4 with the wheels 23 using electric signals, the vehicle 1 may perform any other control.

The manual drive mode allows the vehicle 1 to travel mainly based on, for example, a manual driving operation performed by a driver. For example, the manual drive mode includes a vehicle driving operation mode for driving a vehicle with a driving operation performed by a driver alone, and an assisted driving mode for driving a vehicle mainly with a driving operation performed by a driver in combination with assisted driving.

For example, when the vehicle 1 travels along a curve, assisted driving assists the driver with the steering torque to achieve an appropriate steering quantity based on the curvature of the curve. Assisted driving further includes control for assisting the driver's acceleration (e.g., accelerator pedal operation) or braking (e.g., brake pedal operation), manual steering (manual steering during driving), and manual speed regulation (manual speed control during driving). Manual steering refers to steering the vehicle 1 mainly with the driver's operation on the steering wheel 4. Manual speed regulation refers to adjusting the speed of the vehicle mainly with the driver's accelerating operation or braking operation.

Assisted driving excludes control for forcibly interrupting the driver's driving operation for automatically driving the vehicle. In other words, the manual drive mode reflects the driver's operation on the traveling vehicle within a predetermined allowable range, but excludes any control for forcibly interrupting the vehicle traveling under predetermined conditions (e.g., deviation of the vehicle from a lane).

In contrast, the automatic drive mode enables automatic driving of a vehicle along a road on which the vehicle is traveling. The automatic drive mode includes automatic driving of a vehicle to a predetermined destination without the driver performing a driving operation. The automatic drive mode is not limited to complete automatic control of the vehicle, and includes driving that reflects the driver's operation in the traveling vehicle within a predetermined allowable range. In other words, the automatic drive mode includes control for forcibly interrupting the vehicle travelling under predetermined conditions while reflecting the driver's operation on the traveling vehicle within a predetermined allowable range.

The automatic driving controller 5 controls driving in the automatic drive mode. The automatic driving controller 5 obtains sensing data from a steering sensor 11, an accelerator pedal sensor 12, a brake pedal sensor 13, a global positioning system (GPS) receiver 14, a gyro sensor 15, and a speed sensor 16. The automatic driving controller 5 automatically controls the travelling of the vehicle 1 based on the sensing data, route information generated by a navigation system (not shown), traffic information obtained through road-to-vehicle communication, and information obtained by a surrounding monitoring system that monitors the positions and movements of nearby pedestrians and vehicles.

The automatic control includes autosteering (automatic steering during driving) and automatic speed regulation (automatic speed regulation during driving). Autosteering enables a driving state in which the steering unit 3 is controlled automatically. Autosteering includes lane keeping assist (LKA). LKA automatically controls the steering unit 3 to prevent the vehicle 1 from leaving the driving lane when, for example, the driver is not performing a steering operation. During the operation of LKA, the steering operation of the driver may be reflected in the vehicle steering within the range in which the vehicle 1 stays in the driving lane (allowable range). Autosteering is not limited to LKA.

Automatic speed regulation enables a driving state in which the speed of the vehicle 1 is controlled automatically. Automatic speed regulation includes adaptive cruise control (ACC). For example, ACC controls the vehicle 1 to travel at a predefined constant speed while no preceding vehicle is traveling ahead of the vehicle 1. With a preceding vehicle traveling ahead of the vehicle 1, ACC performs tracking control to regulate the speed of the vehicle 1 in accordance with the distance from the preceding vehicle. During the operation of ACC, the automatic driving controller 5 decelerates the vehicle 1 in response to the driver's braking (e.g., brake pedal operation), or may accelerate the vehicle in response to the driver's acceleration (e.g., accelerator pedal operation) up to a predetermined maximum permissible speed (e.g., the legally defined maximum speed on the road being traveled). Automatic speed regulation is not limited to ACC, but may include cruise control (CC) that performs constant speed control alone.

An automatic driving control system according to one embodiment includes a switch request detector 6a and a drive mode switch controller 6, which switch between the manual drive mode and the automatic drive mode in the vehicle 1, a driver camera 7, which serves as a first monitoring sensor, a torque sensor 8, which serves as a second monitoring sensor, and an alarm generator 9.

The switch request detector 6a detects a switch request for switching from the manual drive mode to the automatic drive mode, and inputs the switch request into the drive mode switch controller 6. The switch request detector 6a may be a switch or a voice recognition device as appropriate. The switch request detector 6a detects, as a switch request, the driver's operation or a voice input requesting drive mode switching, and inputs the switch request into the drive mode switch controller 6. The switch as one example of the switch request detector 6a may be a push button on the steering wheel 4 or a software button on a touch screen.

The driver camera 7 is installed in front of a driver, such as on the dashboard, to capture images of the driver. The driver camera 7 outputs the video signals representing the captured images to the drive mode switch controller 6. The torque sensor 8 detects a torque generated when the driver operates the steering wheel 4, and outputs the detection signal to the drive mode switch controller 6, the wheel drive controller 21, and the motor controller 32. The alarm generator 9 includes a speaker and a display to output the sound signals carrying messages output from the drive mode switch controller 6 through the speaker, and display the display signals carrying the messages on the display.

The drive mode switch controller 6 centrally controls the switching between the drive modes, and has a structure described below.

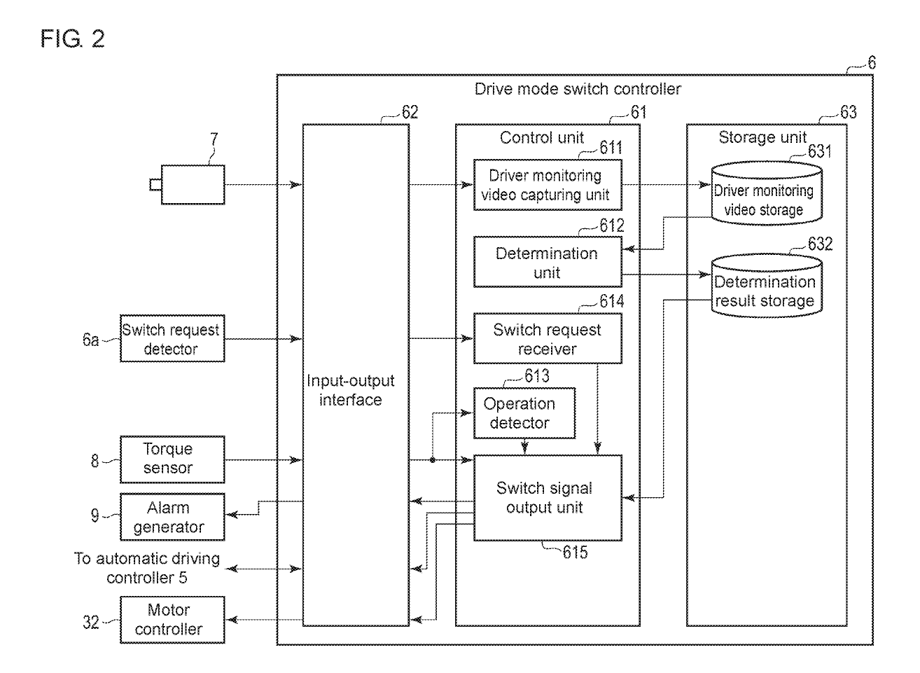

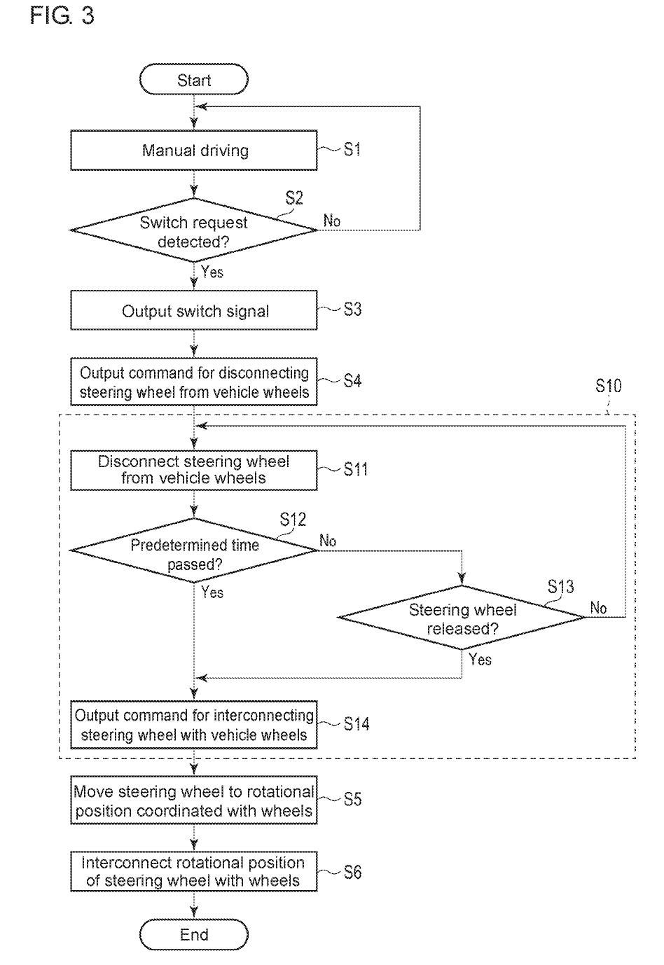

FIG. 2 is a functional block diagram of the drive mode switch controller 6.

The drive mode switch controller 6 includes a control unit 61, an input-output interface 62, and a storage unit 63.

The input-output interface 62 receives video signals output from the driver camera 7 and torque detection signals output from the torque sensor 8, and converts the signals into digital data. Similarly, the input-output interface 62 receives detection signals as sensing data output from each of the steering sensor 11, the accelerator pedal sensor 12, and the brake pedal sensor 13, and converts the signals into digital data. The input-output interface 62 also receives a switch request from the switch request detector 6a. The input-output interface 62 also converts messages output from the control unit 61 into sound signals and display signals, and outputs the signals to the alarm generator 9. Further, the input-output interface 62 outputs switch signals output from the control unit 61 to the automatic driving controller 5.

The storage unit 63 includes, as storage media, a nonvolatile memory, such as a solid state drive (SSD) or a hard disk drive (HDD), which is writable and readable as appropriate, and a volatile memory, such as a random access memory (RAM). The storage unit 63 includes, as a storage area used for implementing one embodiment, a driver monitoring video storage 631 and a determination result storage 632.

The control unit 61 includes a central processing unit (CPU) and a program memory, which form a computer. The control unit 61 includes, as its control functions for implementing one embodiment, a driver monitoring video capturing unit 611, a determination unit 612, an operation detector 613, a switch request receiver 614, and a switch signal output unit 615. These control functions are implemented by the CPU executing programs stored in the program memory.

The driver monitoring video capturing unit 611 receives, through the input-output interface 62, digital data (driver monitoring video data) for the driver video signal output from the driver camera 7, and stores the received driver monitoring video data into the driver monitoring video storage 631 included in the storage unit 63.

The determination unit 612 reads the driver monitoring video data at predetermined time intervals from the driver monitoring video storage 631. Every after reading of the driver monitoring video data, the determination unit 612 determines whether the driver is prepared for manual driving based on the driver monitoring video data. For example, the determination unit 612 determines whether the driver has his or her eyes closed, or specifically whether the driver is asleep. The determination unit 612 then stores information indicating the determination result into the determination result storage 632 in a manner associated with a time stamp indicating the time point of determination.

For example, the determination may include determining the degree of eye opening, the frequency of blinking, or the eye movement of the driver based on the driver monitoring video data to recognize the degree of awakening of the driver. The degree of awakening is an example of the degree of concentration, and is expressed in a range of 0 to 100%. The degree of concentration may be other than a value in a range of 0 to 100%, but may be expressed using a flag with either set to 1 indicating that the gaze direction of the driver is within a predetermined range, or to 0 indicating that the gaze direction is outside the predetermined range. The recognized degree of awakening may be compared with a threshold to determine whether the driver is prepared for performing a manual driving operation.

The determination unit 612 may also determine whether the driver has his or her hands off the steering wheel 4 based on the driver video monitoring data stored in the driver monitoring video storage 631. The determination may include detecting the state of the driver's hands and the steering wheel 4, and determine whether the image of the driver's hands overlaps the image of the steering wheel 4 based on the driver monitoring video data. In place of the driver video monitoring data, the determination unit 612 may use a detection signal from the torque sensor 8 or the steering sensor 11 to determine whether the driver has his or her hands off the steering wheel 4.

The operation detector 613 detects an override operation performed by the driver based on a detection signal output from the torque sensor 8, which is an in-vehicle sensor for detecting a driving operation performed by the driver. The in-vehicle sensor may be other than the torque sensor 8, and may be the steering sensor 11, the accelerator pedal sensor 12, or the brake pedal sensor 13 as appropriate.

The operation detector 613 may detect an override operation while the steering wheel 4 is operating in an interconnected manner with the orientation of the wheels 23 during driving control in the automatic drive mode. In contrast, the operation detector 613 may detect no override operation while the wheels 23 and the steering wheel 4 are disconnected during driving control in the automatic drive mode. In either case, no second switch signal for switching from the automatic drive mode to the manual drive mode is to be output from the switch signal output unit 615 while the wheels 23 and the steering wheel 4 are disconnected. The operation detector 613 may be included in the automatic driving controller 5, instead of being included in the drive mode switch controller 6.

The switch request receiver 614 receives a switch request for switching from the manual drive mode to the automatic drive mode output from the switch request detector 6a, and outputs the received switch request to the switch signal output unit 615. The switch request receiver 614 may store the received switch request into a storage (not shown).

In response to a switch request received by the switch request receiver 614 (or a switch request stored in the storage), the switch signal output unit 615 outputs a first switch signal for switching from the manual drive mode to the automatic drive mode to the automatic driving controller 5, and a disconnecting command for disconnecting the steering wheel from the wheels of the vehicle 1 to the motor controller 32. The disconnecting command may disconnect the steering wheel 4 from the wheels 23 in steer-by-wire control that achieves interconnection between the steering wheel 4 and the wheels 23 using electric signals. After the first switch signal and the disconnecting command are output, the automatic driving controller 5 receiving the first switch signal starts automatic driving. The motor controller 32 receiving the disconnecting command then disconnects the steering wheel 4 from the wheels 23.

The switch signal output unit 615 may perform the processes 1 and 2 described below.

1. A command output process in which an interconnecting command for interconnecting the steering wheel 4 with the wheels 23 of the vehicle 1 is output to the motor controller 32 when a predetermined time period passes after the disconnecting command is output. The command output process may include outputting the interconnecting command without waiting for the predetermined time period when a determination result from the determination unit 612 indicates that the steering wheel 4 is released. The interconnecting command may first move the steering wheel 4 to the rotational position coordinated with the orientation of the wheels 23, and then interconnect the steering wheel 4 with the wheels 23.

2. An override process in which a second switch signal is output for switching from the automatic drive mode to the manual drive mode to the automatic driving controller 5 in response to an override operation detected by the operation detector 613 while the steering wheel 4 and the wheels 23 are interconnected during driving control in the automatic drive mode, and no second switch signal is output in response to an override operation detected while the steering wheel 4 and the wheels 23 are disconnected.

The override process 2 may include outputting the second switch signal to the automatic driving controller 5 in response to an override operation detected by the operation detector 613 in the interconnected state when the determination result obtained by the determination unit 612 immediately before the override operation is detected indicates that the driver is prepared for performing a driving operation. When the operation detector 613 is included in the automatic driving controller 5, the operation detector 613 detecting an override operation described above equates to the automatic driving controller 5 detecting an override operation.

The operation of the drive mode switch controller with the above structure will now be described.

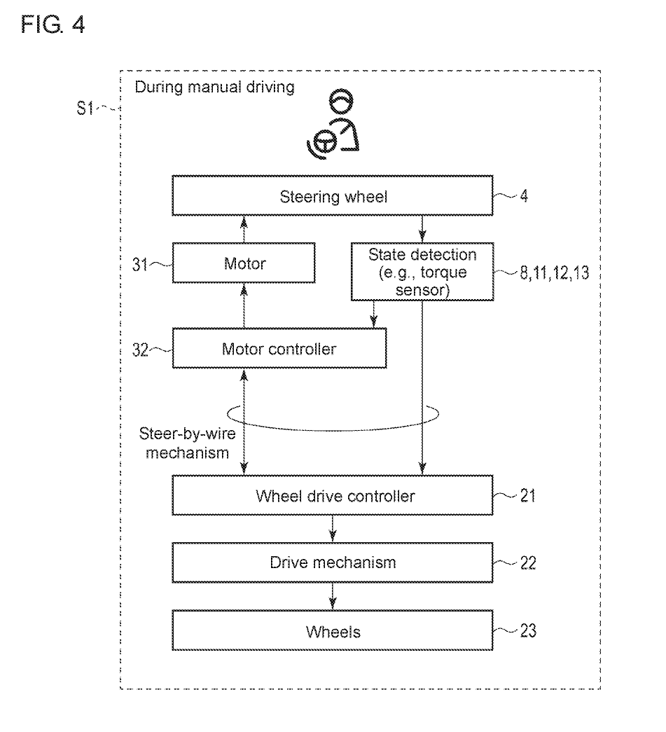

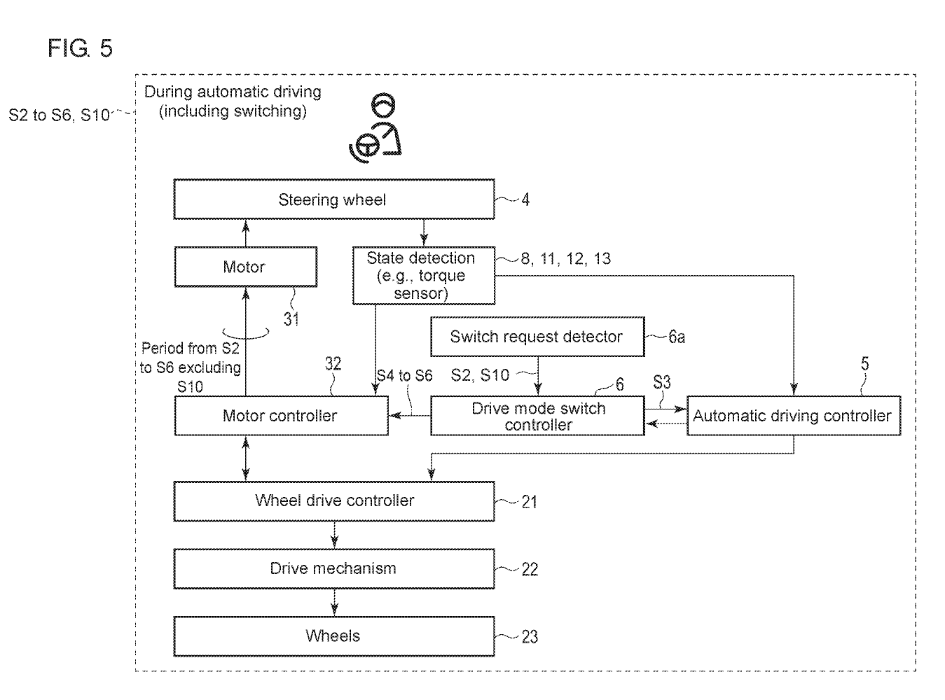

FIG. 3 is a flowchart showing the overall procedure and control associated with the operation. FIGS. 4 and 5 are functional block diagrams associated with the above flowchart.

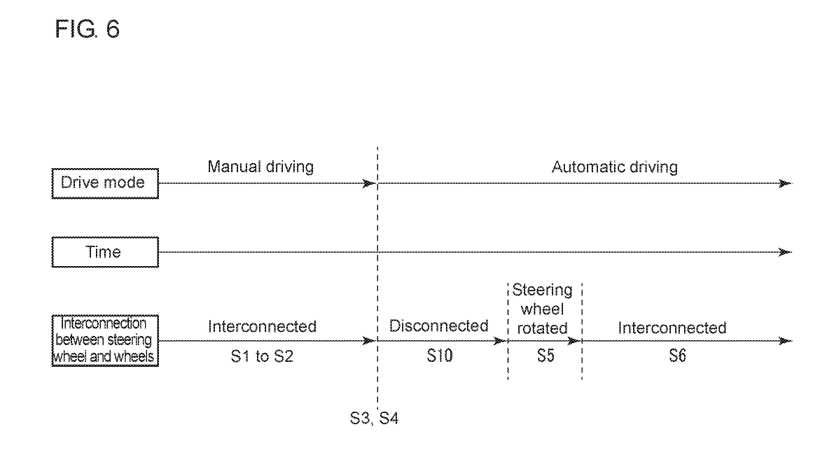

FIG. 6 is a timing chart showing drive modes and interconnected or disconnected states in correspondence with the steps in the above flowchart.

During the operation described below, the driver monitoring video capturing unit 611 stores driver monitoring video data output from the driver camera 7 into the driver monitoring video storage 631. Every after reading of the driver monitoring video data from the driver monitoring video storage 631 at predetermined time intervals, the determination unit 612 determines whether the driver is prepared for performing a manual driving operation, and whether the driver has his or her hands off the steering wheel 4 based on the read driver monitoring video data. The determination unit 612 then stores information indicating the determination result into the determination result storage 632 in a manner associated with a time stamp indicating the time point of determination.

### 1. During Manual Driving

During manual driving in the manual drive mode in step S1, the vehicle 1 uses, for example, steer-by-wire control that interconnects the rotational position of the steering wheel 4 with the orientation of the wheels 23 using electric signals in accordance with the driver's driving operation for manual driving. For example, as shown in FIG. 4, the sensors 8 and 11 to 13 detect the state of, for example, the steering wheel 4, and output the detection signals to the wheel drive controller 21. The wheel drive controller 21 controls the orientation of the wheels 23 and their rotation speed via the drive mechanism 22 based on the detection signals. The wheel drive controller 21 also outputs the wheel state information indicating the orientation of the wheels 23 to the motor controller 32. The motor controller 32 controls the rotational position of the steering wheel 4 via the motor 31 based on the wheel state information.

As shown in FIGS. 3 and 5, the drive mode switch controller 6 receives a switch request output when the switch request detector 6a detects a switch request for switching from the manual drive mode to the automatic drive mode in step S2 as controlled by the switch request receiver 614. The switch request receiver 614 outputs the received switch request to the switch signal output unit 615.

### 2. Outputting Signal for Switching to Automatic Driving

The switch signal output unit 615 outputs the first switch signal for switching from the manual drive mode to the automatic drive mode to the automatic driving controller 5 in step S3 in response to the switch request received by the switch request receiver 614. In response to this, the automatic driving controller 5 ends the manual drive mode, and subsequently performs driving control in the automatic drive mode. To allow the driver to feel actual switching to the automatic drive mode, the processing in step S4 and subsequent steps is performed. More specifically, the switch signal output unit 615 outputs, in response to the switch request, the disconnecting command for disconnecting the steering wheel 4 from the wheels 23 of the vehicle 1 to the motor controller 32 in step S4. This disconnecting command disconnects the steering wheel 4 from the wheels 23 in steer-by-wire control that achieves interconnection between the steering wheel 4 and the wheels 23 using electric signals.

3. Disconnecting Steering Wheel 4 from Wheels 23

The drive mode switch controller 6 performs step S10 including sub-steps S11 to S14 as controlled by the switch signal output unit 615.

More specifically, the switch signal output unit 615 outputs the disconnecting command to the motor controller 32, which causes the motor controller 32 to stop controlling the motor 31. Thus, the motor controller 32 disconnects the steering wheel 4 from the wheels 23 (step S11). This causes the steering wheel 4 to be movable to any rotational position. The switch signal output unit 615 outputs no second switch signal for switching from the automatic drive mode to the manual drive mode in response to an override operation detected by the operation detector 613 while the steering wheel 4 and the wheels 23 are disconnected during driving control in the automatic drive mode.

Thus, the driver operating the steering wheel can confirm that the rotational position of the steering wheel is no longer interconnected with the orientation of the wheels 23, and feel actual switching to the automatic drive mode.

Subsequently, the switch signal output unit 615 that has output the disconnecting command determines whether a predetermined time period has passed (step S12). When the predetermined time period passes, the processing advances to step S14. When the predetermined time period has yet to pass, the determination unit 612 determines whether the driver has his or her hands off the steering wheel 4 (step S13). When the determination result indicates that the steering wheel 4 has been released, the processing advances to step S14 before the predetermined time period passes. When the steering wheel is held, the processing returns to step S11.

The switch signal output unit 615 outputs the interconnecting command for interconnecting the steering wheel 4 with the wheels 23 of the vehicle 1 to the motor controller 32 in step S14. The interconnecting command moves the steering wheel 4 to the rotational position coordinated with the orientation of the wheels 23, and then interconnects the steering wheel 4 with the wheels 23.

4. Interconnecting Steering Wheel 4 with Wheels 23

The switch signal output unit 615 outputs the interconnecting command to the motor controller 32, which causes the motor controller 32 to resume controlling the motor 31. In response to the interconnecting command, the motor controller 32 controls the motor 31 based on the wheel state information received from the wheel drive controller 21, and moves the steering wheel 4 to the rotational position coordinated with the orientation of the wheels 23 (step S5). The motor controller 32 then controls the motor 31 based on the wheel state information to interconnect the rotational position of the steering wheel 4 with the orientation of the wheels 23 (step S6).

As shown in FIG. 6, the switching from the manual drive mode to the automatic drive mode described above is completed through the interconnected state of the steering wheel 4 and the wheels 23 (steps S1 and S2), the mode switching state (steps S3 and S4), the disconnected state (step S10), the coordinated state in which the steering wheel 4 is rotated to an intended position (step S5), and the interconnected state (step S6).

5. Interconnected during Automatic Driving

The vehicle 1 performs automatic driving using, for example, steer-by-wire control that interconnects the rotational position of the steering wheel 4 with the orientation of the wheels 23 using electric signals during driving control in the automatic drive mode performed by the automatic driving controller 5.

The driver may perform a driving operation while the steering wheel 4 and the wheels 23 are interconnected during driving control in the automatic drive mode. In this case, the operation detector 613 detects an override operation performed by the driver based on, for example, a detection signal output from the torque sensor 8.

In response to an override operation detected by the operation detector 613 in the interconnected state, the switch signal output unit 615 determines whether the determination result from the determination unit 612 obtained immediately before the override operation is detected indicates that the driver is prepared for performing a driving operation. When the determination result indicates that the driver is prepared for performing a driving operation, the switch signal output unit 615 outputs the second switch signal for switching from the automatic drive mode to the manual drive mode to the automatic driving controller 5. In response to this, the automatic driving controller 5 ends the automatic drive mode, and subsequently performs driving control in accordance with the driver's manual operation.

As described in detail above, in the embodiment of the present invention, a switch request for switching from the manual drive mode to the automatic drive mode is received, the first switch signal for switching from the manual drive mode to the automatic drive mode is output in response to the switch request, and the disconnecting command for disconnecting the steering wheel 4 from the wheels 23 of the vehicle is output. Thus, the driver operating the steering wheel can confirm that the steering wheel operation is no longer interconnected with the wheels 23 after switching to the automatic drive mode. This allows the driver to feel actual switching to the automatic drive mode. Further, the steering wheel operation is no longer interconnected with the wheels 23, thus preventing switching from the automatic drive mode to the manual drive mode.

This allows the driver to feel actual switching to the automatic drive mode, while preventing switching to the manual drive mode.

Also, when the predetermined time period passes after the disconnecting command is output, the interconnecting command is output for interconnecting the steering wheel 4 with the wheels 23 of the vehicle 1. This structure allows the steering wheel 4 to be interconnected with the wheels 23 after allowing the driver to feel actual switching to the automatic drive mode. This structure enables switching to the manual drive mode with the steering wheel interconnected with the wheels 23 at an appropriate position in response to an override operation performed in the interconnected state during automatic driving.

An override operation performed by the driver is detected based on a detection signal output from an in-vehicle sensor for detecting the driver's driving operation. In response to an override operation detected while the steering wheel 4 and the wheels 23 are interconnected during driving control in the automatic drive mode, the second switch signal is output for switching from the automatic drive mode to the manual drive mode. In response to an override operation detected while the steering wheel 4 and the wheels 23 are disconnected, no second switch signal is output. Thus, while the steering wheel and the wheels 23 are disconnected subsequent to switching to the automatic drive mode, the driver performing an override operation can confirm that the wheels 23 are no longer interconnected, allowing the driver to feel actual switching to the automatic drive mode. Also, in response to an override operation detected while the steering wheel and the wheels are disconnected, no second switch signal is output for switching to the manual drive mode.

The determination as to whether the driver has his or her hands off the steering wheel 4 is performed. When the determination result indicates that the driver has his or her hands off the steering wheel 4, the interconnecting command is output without waiting for the predetermined time period. The steering wheel 4 can be interconnected with the wheels 23 without waiting for the predetermined time period when the driver promptly feels actual switching to the automatic drive mode.

The interconnecting command moves the steering wheel 4 to the rotational position coordinated with the orientation of the wheels 23, and then interconnects the steering wheel 4 with the wheels 23. Thus, the steering wheel 4 is moved toward the rotational position coordinated with the orientation of the wheels 23 during shifting from the released state to the interconnected state.

The disconnecting command disconnects the steering wheel 4 from the wheels 23 in steer-by-wire control that achieves interconnection between the steering wheel 4 and the wheels 23 using electric signals. The controller can thus be used for a vehicle with steer-by-wire control.

### Other Embodiments

The present invention is not limited to the embodiment described above. In some embodiments, step S13 shown in FIG. 3 may be eliminated, and the processing may return to step S11 when a determination result in step S12 is negative.

The vehicle 1 may mechanically connect or disconnect the steering wheel 4 and the wheels 23 with a shaft and a clutch, in place of using steer-by-wire control for electrically connecting or disconnecting the steering wheel 4 and the wheels 23 using electric signals.

Although the switch signal output unit 615 outputs the disconnecting command to the motor controller 32 according to one embodiment, the invention is not limited to the embodiment. In some embodiments, the switch signal output unit 615 may output the disconnecting command to the automatic driving controller 5, and the automatic driving controller 5 may output the disconnecting command to the motor controller 32. In other words, the switch signal output unit 615 may output the disconnecting command to the motor controller 32 via the automatic driving controller 5.

Similarly, although the switch signal output unit 615 outputs the interconnecting command to the motor controller 32 according to one embodiment, the invention is not limited to this embodiment. In some embodiments, the switch signal output unit 615 may output the interconnecting command to the automatic driving controller 5, and the automatic driving controller 5 may output the interconnecting command to the motor controller 32. In other words, the switch signal output unit 615 may output the interconnecting command to the motor controller 32 via the automatic driving controller 5.

Although the motor controller 32 controls the motor 31 based on the wheel state information received from the wheel drive controller 21 in step S5 in the present embodiment, the embodiment is not limited to this control. For example, the motor controller 32 may control the motor 31 based on the wheel state information received from the automatic driving controller 5.

Further, the switch signal output unit 615 in the present embodiment can output a second switch signal for switching from the automatic drive mode to the manual drive mode when detecting an override operation immediately after switching to the automatic drive mode. In some embodiments, the operation detector 613 may overlook any override operation for a predetermined time period starting immediately after switching to the automatic drive mode. In other words, the operation detector 613 detects no override operation during the predetermined time period starting immediately after switching to the automatic drive mode, and thus the switch signal output unit 615 outputs no second switch signal during the predetermined time period. Such modifications allow the driver to feel actual switching to the automatic drive mode while preventing switching to the manual drive mode in the same manner as in the above embodiment.

Other details including the type of vehicle, the functions of the automatic driving controller, and the functions, procedure, and control of the drive mode switch controller may be modified variously without departing from the spirit and scope of the present invention.

In other words, the present invention is not limited to the embodiments described above, but may be variously modified without departing from the spirit and scope of the invention. The above embodiments may be combined in any possible manner to achieve effects produced by such combinations. The components described in the above embodiments may further be selected or combined to provide various aspects of the invention.

The above embodiment may be partially or entirely expressed in, but not limited to, the following forms shown in the appendixes below.

### APPENDIX 1

A drive mode switch controller for switching a drive mode of a vehicle between a manual drive mode and an automatic drive mode, the controller comprising:

a memory configured to store a switch request for switching from the manual drive mode to the automatic drive mode, and

at least one hardware processor connected to the memory, the at least one hardware processor being configured to

receive an input switch request and store the switch request into the memory, and

output, in response to the switch request stored in the memory, a first switch signal for switching from the manual drive mode to the automatic drive mode, and a disconnecting command for disconnecting a steering wheel from wheels of the vehicle.

### APPENDIX 2

A drive mode switch control method implemented by a controller for switching a drive mode of a vehicle between a manual drive mode and an automatic drive mode, the method comprising:

receiving, with at least one hardware processor, a switch request for switching from the manual drive mode to the automatic drive mode, and storing the switch request into at least one memory; and

outputting, with the at least one hardware processor, in response to the switch request stored in the memory, a first switch signal for switching from the manual drive mode to the automatic drive mode, and a disconnecting command for disconnecting a steering wheel from wheels of the vehicle.

1. A drive mode switch controller for switching a drive mode of a vehicle between a manual drive mode and an automatic drive mode, the controller comprising a processor configured with a program to perform operations comprising:
operation as a switch request receiver configured to receive a switch request for switching from the manual drive mode to the automatic drive mode;
operation as a switch signal output unit configured to output, in response to the switch request received by the switch request receiver, a first switch signal for switching from the manual drive mode to the automatic drive mode, and a disconnecting command for disconnecting a steering wheel from wheels of the vehicle; and
operation as an operation detector configured to detect, in response to a detection signal output from an in-vehicle sensor for detecting a driving operation of a driver, an override operation of the driver, the in-vehicle sensor comprising an accelerator pedal sensor or a brake pedal sensor, wherein
the processor is configured with the program perform operations such that operation as the switch signal output unit comprises:
operation as a command output unit configured to output, in response to a predetermined time period passing after the disconnecting command is output, an interconnecting command for interconnecting the steering wheel with the wheels of the vehicle; and
operation as an override processor configured to output a second switch signal for switching from the automatic drive mode to the manual drive mode in response to an override operation detected by the operation detector while the steering wheel and the wheels are interconnected during driving control in the automatic drive mode, and output no second switch signal in response to the override operation detected while the steering wheel and the wheels are disconnected during driving control in the automatic drive mode.

2. (canceled)

3. (canceled)

4. The drive mode switch controller according to claim 1, wherein
the processor is configured with the program perform operations further comprising operation as a determination unit configured to determine whether the driver has hands being off the steering wheel, and
the processor is configured with the program perform operations such that operation as the command output unit is further configured to output the interconnecting command before the predetermined time period passes in response to a determination result from the determination unit indicating that the driver has the hands being off the steering wheel.

5. The drive mode switch controller according to claim 1, wherein the processor is configured with the program perform operations such that operation as the interconnecting command is further configured to move the steering wheel to a rotational position coordinated with an orientation of the wheels before interconnecting the steering wheel with the wheels.

6. The drive mode switch controller according claim 1, wherein the processor is configured with the program perform operations such that operation as the disconnecting command is further configured to disconnect the steering wheel from the wheels in a steer-by-wire control operation that interconnects the steering wheel and the wheels using electric signals.

7. A drive mode switch control method implemented by a controller for switching a drive mode of a vehicle between a manual drive mode and an automatic drive mode, the method comprising:
receiving, with the controller, a switch request for switching from the manual drive mode to the automatic drive mode;
outputting, with the controller, a first switch signal for switching from the manual drive mode to the automatic drive mode in response to the switch request received in the receiving the switch request, and outputting a disconnecting command for disconnecting a steering wheel from wheels of the vehicle;
detecting, with the controller, in response to a detection signal output from an in-vehicle sensor for detecting a driving operation of a driver, an override operation of the driver:
outputting, with the controller, no second switch signal for switching from the automatic drive mode to the manual drive mode in response to the override operation detected while the steering wheel and the wheels are disconnected during driving control in the automatic drive mode;
outputting, with the controller, in response to a predetermined time period passing after the disconnecting command is output, an interconnecting command for interconnecting the steering wheel with the wheels of the vehicle; and
outputting, with the controller, the second switch signal in response to an override operation detected while the steering wheel and the wheels are interconnected during driving control of the automatic drive mode, wherein
the in-vehicle sensor comprises an accelerator pedal sensor or a brake pedal sensor.

8. A non-transitory computer-readable storage medium storing a program, which when read and executed, causes a computer to perform the operations in the drive mode switch controller according to claim 1.

9. The drive mode switch controller according to claim 4, wherein the processor is configured with the program perform operations such that operation as the interconnecting command is further configured to move the steering wheel to a rotational position coordinated with an orientation of the wheels before interconnecting the steering wheel with the wheels.

10. The drive mode switch controller according claim 4, wherein the processor is configured with the program perform operations such that operation as the disconnecting command is further configured to disconnect the steering wheel from the wheels in steer-by-wire control that achieves interconnection between the steering wheel and the wheels using electric signals.

11. The drive mode switch controller according claim 5, wherein the processor is configured with the program perform operations such that operation as the disconnecting command is further configured to disconnect the steering wheel from the wheels in a steer-by-wire control operation that interconnects the steering wheel and the wheels using electric signals.

12. A non-transitory computer-readable storage medium storing a program, which when read and executed, causes a computer to perform the operations of the drive mode switch controller according to claim 4.

13. A non-transitory computer-readable storage medium storing a program, which when read and executed, causes a computer to perform the operations of the drive mode switch controller according to claim 5.

14. A non-transitory computer-readable storage medium storing a program, which when read and executed, causes a computer to perform the operations of the drive mode switch controller according to claim 6.

15. A non-transitory computer-readable storage medium storing a program, which when read and executed, causes a computer to perform the operations of the drive mode switch controller according to claim 9.

16. A non-transitory computer-readable storage medium storing a program, which when read and executed, causes a computer to perform the operations of the drive mode switch controller according to claim 10.

17. A non-transitory computer-readable storage medium storing a program, which when read and executed, causes a computer to perform the operations of the drive mode switch controller according to claim 11.
